(19) United States
(12) Patent Application Publication
(10) Pub. No.: US 2016/0170058 A1
(43) Pub. Date: Jun. 16, 2016

(54) METHOD AND SYSTEM OF SEISMIC DATA PROCESSING

(71) Applicant: Gary HAMPSON, Claremont (AU)

(72) Inventor: Gary HAMPSON, Claremont (AU)

(73) Assignee: CHEVRON U.S.A. INC., San Ramon, CA (US)

(21) Appl. No.: 14/568,557

(22) Filed: Dec. 12, 2014

(51) Int. Cl. G01V 1/36; G01V 1/38

(52) U.S. Cl. CPC G01V 1/364; G01V 1/38; G01V 2210/324

(57) ABSTRACT

The present invention relates to processing of seismic data. More specifically, the present invention relates to processing of low-cut filtered seismic data to reduce or suppress transient effects.

### TECHNICAL FIELD

The present invention relates to processing of seismic data. More specifically, the present invention relates to low-cut filtering of seismic data to reduce or suppress transient effects.

### BACKGROUND OF THE INVENTION

In the field of seismic data processing, such as marine seismic data processing, acquisition techniques include using low-cut filters to reduce low-frequency noise on the acquired data. Low-cut filtering may however inadvertently or inevitably cause undesirable artefacts on the acquired data. In particular, the finite amplitude of a signal at the start and at the end of the recoding time window may manifest in the filtered data as unwanted distortions or “transient effects”. Any such transient effects may mask useful or important signatures of the acquired signal.

### SUMMARY

In a first aspect of the present disclosure, there is provided a computer-implemented method of low-cut filtering a seismic trace recorded over a recording time window, the method comprising:

applying a causal low-cut filter to the seismic trace to generate first filtered data;

applying an anti-causal low-cut filter to the seismic trace to generate second filtered data;

truncating the first filtered data to generate first truncated data based on the recording time window;

truncating the second filtered data to generate second truncated data based on the recording time window;

removing the phase of the first truncated data;

removing the phase of the second truncated data;

selecting a portion of the first phase-removed truncated data to generate first modified data, the selected portion of the first phase-removed truncated data being associated with a later time interval of the seismic trace;

selecting a portion of the second phase-removed truncated data to generate second modified data, the selected portion of the second phase-removed truncated data being associated with an earlier time interval of the seismic trace; and

generating a low-cut filtered seismic trace by combining at least the first modified data and the second modified data.

The step of removing the phase of the first truncated data may include applying a phase removal filter to the first truncated data. The phase removal filter may include an all-pass filter with a conjugate phase of the causal filter. Alternatively, the phase removal filter may include a time-reversed version of the causal filter.

The step of removing the phase of the second truncated data may include applying a phase removal filter to the second truncated data. The phase removal filter may include an all-pass filter with a conjugate phase of the anti-causal filter. Alternatively the phase removal filter may include a time-reversed version of the anti-causal filter.

Applying a causal low-cut filter to the seismic trace to generate first filtered data may include computing discrete convolution of the seismic trace and the impulse response of the causal low-cut filter, and wherein truncating first filtered data may include removing convolution artefacts arising from the discrete convolution. Truncating to remove convolution artefacts may include truncating to the recording time window of the seismic trace.

Applying an anti-causal low-cut filter to the seismic trace to generate second filtered data may include computing discrete convolution of the seismic trace and the impulse response of the anti-causal low-cut filter, and wherein truncating second filtered data may include removing convolution artefacts arising from the discrete convolution. Truncating to remove convolution artefacts may include truncating to the recording time window of the seismic trace.

The earlier interval of the seismic trace and the later interval of the seismic trace may each be a temporal half of the seismic trace.

The seismic trace may include an intermediate interval between the earlier interval and the later interval of the seismic trace, and wherein generating a low-cut filtered seismic trace may include combining the first modified data, the second modified data and data associated with the intermediate interval.

The causal filter may be a minimum phase filter.

The anti-causal filter may be a maximum phase filter.

In one example, the anti-causal or causal low-cut filter includes a cut off frequency of 2 Hz or less.

In one example, the anti-causal or causal low-cut filter includes an amplitude roll off of 12 dB per octave.

The anti-causal or causal low-cut filter may include any one of a one-dimensional filter, a two-dimensional F-K filter and an N-dimensional filter.

For a one dimensional filter, the independent variable of the one-dimensional filter may be space, frequency or voltage.

In a second aspect of the present disclosure, there is provided a system configured for low-cut filtering a seismic trace, the system comprising:

an input for receiving the seismic trace;

one or more processing units configured to execute the method of the first aspect; and

an output for providing the low-cut filtered seismic trace.

In a third aspect of the present disclosure, there is provide a non-transitory machine-readable medium comprising instructions coded thereon for one or more processing units to execute the method of the first aspect.

Further aspects of the present disclosure and further embodiments of the aspects described in the preceding paragraphs will become apparent from the following description, given by way of example and with reference to the accompanying drawings.

### BRIEF DESCRIPTION OF THE DRAWINGS

Embodiments and features of the present disclosure will be described with reference to the accompanying figures in which:

FIG. 1 illustrates an input sinusoidal time series (in solid lines) and the times series filtered by a 2-Hz low cut filter;

FIG. 2 illustrates an example of a method of low-cut filtering according to the present disclosure;

FIG. 3 illustrates suppression or reduction of transient effects by a causal filter towards the end of the recording window;

FIG. 4 illustrates the filtered output of FIG. 3 having been partially nulled and then having a time-reversed version of the causal filter applied;

FIGS. 5A and 5B illustrate the impulse response and the frequency response (amplitude and phase), respectively, of an example of a causal filter;

FIG. 6 illustrates an example of towed streamer data;

FIG. 7A illustrates causally filtered and partially nulled streamer data;

FIG. 7B illustrates anti-causally filtered and partially nulled streamer data;

FIG. 7C illustrates the combined data illustrated in FIGS. 7B and 7C;

FIG. 8 illustrates the towed streamer data of FIG. 6 having been low-cut filtered by a conventional method; and

FIG. 9 illustrates an example of a computer system suited for implementing the computer-implemented method according to the present disclosure.

### DETAILED DESCRIPTION OF THE INVENTION

Described herein is a method of processing of seismic data. More specifically, the present invention aims to low-cut filter seismic data with reduced or suppressed transient effects. Also described herein are the corresponding system and computer-readable medium which implement such a method.

The present disclosure is suited for use with processing marine seismic data. However, the present disclosure may also have broader application in other fields in which finite length segments of time series are filtered. It is also equally applicable to digitized functions of any other independent variable besides time, for example, space or frequency.

### Transient Effects

In marine seismic surveys, broadband acquisition techniques sometimes use very low low-cut field filters. In some instances, the instrument filters are “out”, or otherwise incorrectly configured, and the only low-cut filter effect may come from the hydrophone RC filter effect, which can be inadequate. As a result, significant low-frequency noise is often recorded and requires some form of attenuation or manipulation during data processing. For example, surface waves on the sea have a decaying pressure field at depth which is recorded by the hydrophones as a very low frequency (˜0.1 to 2 Hz) slowly moving (2 to 6 m/s) wave field. The exact details of surface waves depend very much on their amplitude, wavelength and direction of propagation relative to the streamer.

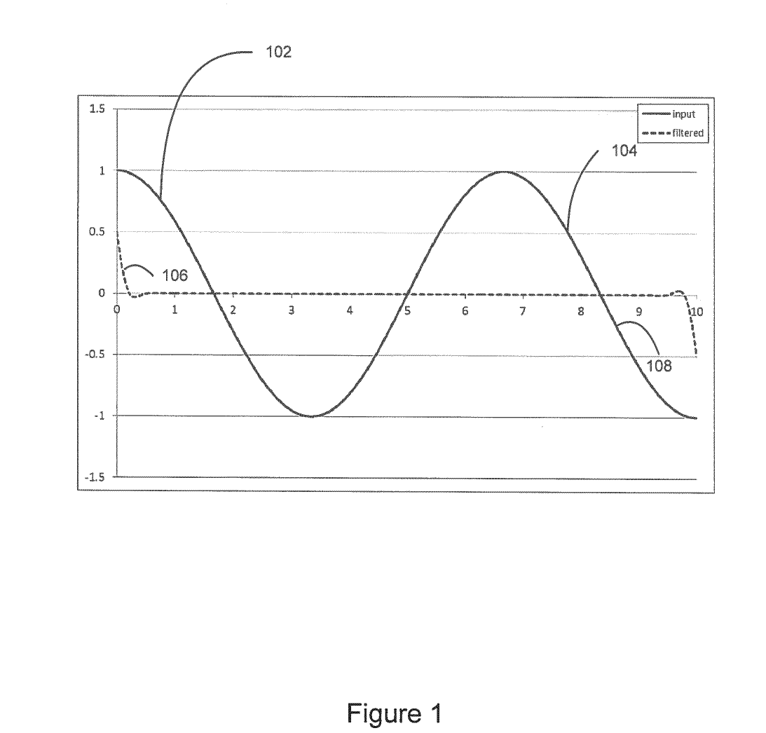

Data acquisition captures data in a finite recording time window. The finite amplitude or value of a signal at the start and the end of the recording time window may manifest in the filtered data as unwanted transient effects. To illustrate the transient effects due to low-cut filtering data which has low-frequency components, consider a finite segment of single-frequency data. FIG. 1 illustrates an input 102 which is a 0.15 Hz sinusoidal time series. The horizontal axis represents time in seconds and the vertical axis represents data amplitude in an arbitrary scale. The time series lasts for 1.5 cycles and has non-zero amplitudes at the start and the end of the time window. Also illustrated in FIG. 1 is the input 102 having been filtered as output 104 using a 2-Hz low cut filter. The output 104 has zero (or almost zero) amplitudes except for the contribution from the ends of the time series 106, 108. The contribution contaminates the output for approximately 1 second at each end within the duration of the time series. Because low-cut filters have long responses, a simple low-cut filter for the removal of low frequency noise will contaminate a significant portion of the time series. Such distortions or transient effects at the ends of the recording time window may become significant if their amplitudes mask the actual data.

The transient effects may be better understood mathematically. In typical seismic measurements, the amplitudes at the beginning and the end of a seismic trace are expected to be zero or close to zero. This is because with a typical low-cut filter there is no energy anticipated before the seismic source fires and negligible energy at the end of the seismic record. However, if the low filters are “out”, energy that is not related to the seismic source, such as surface waves, is recorded and effectively has an abrupt start and end imposed by the recording window. Given such a window function w(t) of time t with a window length of a,

$$w ( t ) = \{ \begin{matrix}1 & \vert t \vert < \frac{a}{2} \\ 0 & \vert t \vert > \frac{a}{2}\end{matrix} \qquad ( 0 )$$

applied to pressure wavefield, p(t), we have an output:

u(t)=w(t)·p(t). (0)

If we should then apply a digital filter, f(t), we will have the resulting data given by,

d(t)=f(t)*[w(t)·p(t)]. (0)

where * denotes convolution. To demonstrate the effect of the filter on the windowed pressure function, consider taking the derivative with respect to time,

$$\frac{d}{d t} d ( t ) = f ( t ) * \frac{d}{d t} [ w ( t ) \cdot p ( t ) ] = f ( t ) * [ \frac{d w}{d t} \cdot p + w \cdot \frac{d p}{d t} ] . \qquad ( 0 )$$

Now if p(t) is smoothly varying then the second term in brackets w·(dp/dt) will contribute only weakly. The first term in brackets (dw/dt)·p will be everywhere zero, except at the window ends so that,

$$\frac{d}{d t} d ( t ) \approx f ( t ) * [ p ( t ) \cdot ( δ ( t + a / 2 ) - δ ( t - a / 2 ) ) ] . \qquad ( 0 )$$

where δt) is the Dirac delta function. We invoke the sifting property and see that upon re-integration,

d(t)≈∫_{-∞}^{+∞}f(t)dt*[p(−a/2)−p(+a/2)]. (0)

It may be concluded that, at the start and end of the recoding window, impulses proportional to p(−a/2) and −p(+a/2) respectively, will be present. Their shape is the time integral of the filter. The duration of ∫_{-∞}^{+∞}f(t)dt and the amplitudes of p(t) at the window ends are important because they determine how badly d(t) is contaminated.

From FIG. 1, it can be seen that low cut filtering is generally effective except for the transients generated at the trace ends within the recording window. The transient effects arise because filtering implies that the trace is zero outside the recording window. One way to estimate the sinusoidal content in a window of limited length is to avoid using the zero sample values in the estimate.

### Reducing Transient Effects

A method is disclosed to reduce or suppress the transient effects on low-cut filtered seismic data of a finite recording time window. The disclosed method separately applies a causal filter and an anti-causal filter to input data and combines selected portions of the causally and anti-causally filtered data to generate a full set of low-cut filtered data.

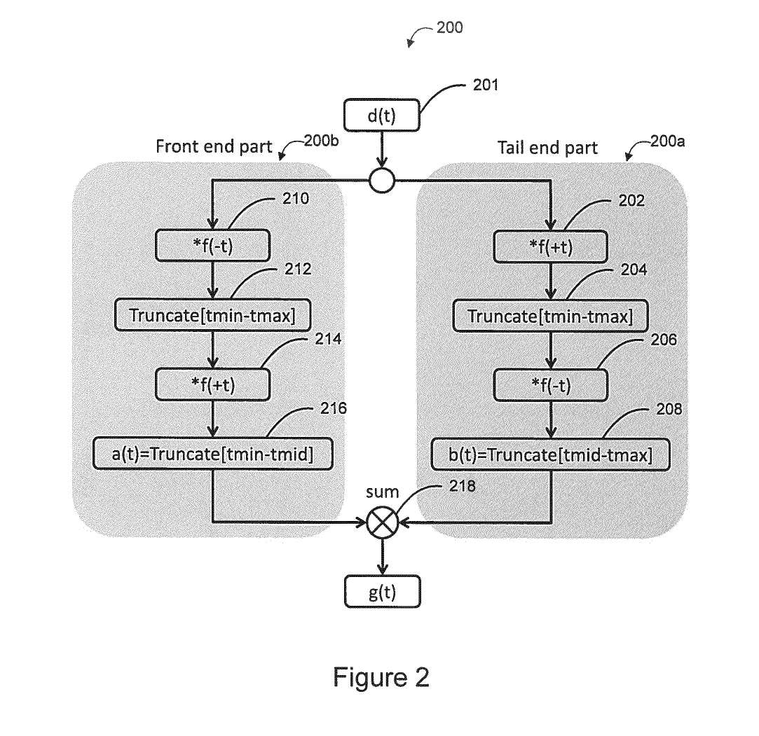

In one general form, as schematically illustrated in FIG. 2, the disclosed method 200 comprises essentially two streams of steps. The first stream 200a comprises: the step 202 of applying a causal low-cut filter f(+t) to an input seismic trace d(t) 201 to generate first filtered data, the step 204 of truncating the first filtered data generate first truncated data based on the recording time window, the step 206 of removing the phase of the first truncated data, the step 208 of selecting a portion of the first phase-removed truncated data to generate first modified data, the selected portion of the phase-removed truncated data being associated with a later time interval of the seismic trace. The second stream 200b comprises: the step 210 of applying an anti-causal low-cut filter f(−t) to the seismic trace d(t) to generate second filtered data, the step 212 of truncating the second filtered data to generate second truncated data based on the recording time window, the step 214 of removing the phase of the second truncated data, the step 216 of selecting a portion of the second phase-removed truncated data to generate second modified data, the selected portion of the second phase-removed truncated data being associated with an earlier time interval of the seismic trace, and the step 218 of generating a low-cut filtered output seismic trace by combining at least the first modified data and the second modified data.

A person skilled in the art would appreciate that the disclosed method 200 does not require, to the extent possible, strict compliance to the order in which the steps are introduced above or in FIG. 2. For example, in another general form of the method, the order of the first stream and the second stream may be swapped or they may be executed in parallel. Furthermore, the skilled person would appreciate that the steps 208 and 216 of selection may be alternatively implemented by nulling or disregarding, or truncating a complementary portion of the relevantly filtered data. Similarly, the steps 204 and 212 of truncation may be replaced by nulling a relevant portion of the filtered data.

The disclosed method may be computer-implemented, for example by a computer system having an input for receiving the seismic trace, one or more processing units configured to execute the disclosed method, and an output for providing the low-cut filtered seismic trace. The disclosed method may be coded as machine-readable instructions on a non-transitory machine-readable medium for the one or more processing units to execute the method.

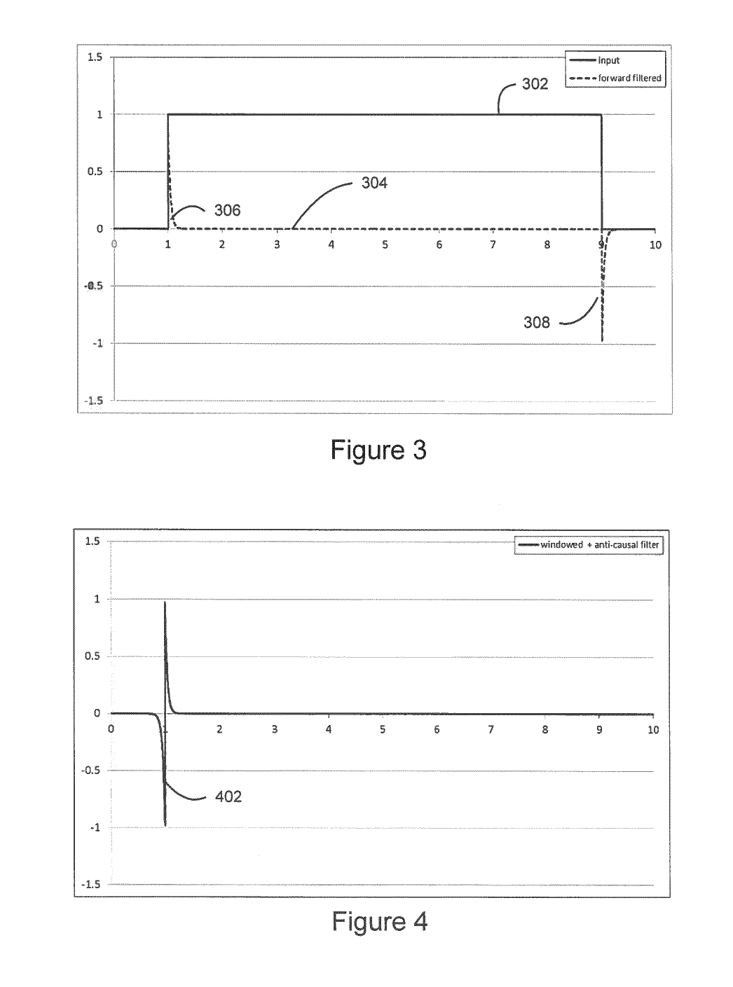

The reduction or suppression of the transient effects by the disclosed method may be illustrated through explanatory examples. FIG. 3 illustrates the suppression or reduction of transient effects towards the end of the recording window. In FIG. 3, an output 304 (dashed line) is generated by applying a causal filter to a rectangle input function 302 (solid line) having an arbitrary amplitude of 1 between arbitrary time units 1 to 9 (solid line). While the causal filter causes distortions (see upward spike 306) to the output 304 near the start of the rectangle input function, the causal filter causes no distortion or no significant distortion to the output up until the end of the rectangle input function.

The application of a causal filter in the temporal domain on the seismic trace (that is, via convolution of the impulse response of causal filter and the seismic data) performs in a well-behaved manner up to the last sample on the seismic trace because all the contributions are taken from existing samples. However, at the beginning of the trace the scenario is different. There, contributions to output samples are taken implicitly from samples prior to the first sample of the seismic trace so that the time window at the start of the output trace that is equivalent in length to the filter is distorted due to lack of valid contributions. For similar reasons, data beyond the end of the rectangle input function 302 are also distorted (see downward spike 308). Still referring to FIG. 3, the output 304 generated by applying a causal filter to the rectangle input function 302 however provides little or no distortion up until the end of the rectangle input function.

Therefore, when a seismic trace is filtered by a causal filter, the portion of the filtered seismic data associated with the later interval of the seismic trace can be undistorted or substantially undistorted. This undistorted or substantially undistorted portion of the filtered seismic data (e.g. the later half) may be selected. The selected portion of the causally filtered may be stored. The rest of the data portions may be truncated, nulled or otherwise disregarded. In other words, to reduce or suppress transient effects at the later interval of the seismic trace, corresponding input data may be first filtered by a low-cut causal filter. Thereafter, the portion of the filtered data associated with an earlier interval (e.g. the earlier half) of the seismic trace as well as the portion of the filter data beyond the end of the rectangle input may be truncated, nulled or otherwise disregarded. The resulting modified data represent an undistorted portion (e.g. later half) of the low-cut filtered seismic trace.

In a similar manner, although not illustrated, if an anti-causal filter is applied to the rectangle function, the anti-causal filter causes distortions to the output near the end of the rectangle input function, but no distortion or significant distortion to the output near the start of the rectangle input function. Therefore, when the seismic trace is filtered by an anti-causal filter, the portion of the filtered seismic data associated with the earlier interval of the seismic trace can be undistorted or substantially undistorted. This undistorted or substantially undistorted portion of the filtered seismic data (e.g. the earlier half) may be selected. The selected portion of the causally filtered data may be stored. The rest of the data portions may be truncated, nulled or otherwise disregarded. In other words, to reduce or suppress transient effects at the earlier interval of the seismic trace, corresponding input data may be first filtered by a low-cut anti-causal filter. Thereafter, the portion of the filtered data associated with a later interval (e.g. the later half) of the seismic trace as well as the portion of the filter data beyond the start of the rectangle input may be truncated, nulled or otherwise disregarded. The resulting modified data represent an undistorted portion (e.g. earlier half) of the low-cut filtered seismic trace.

To generate a full low-cut filtered seismic trace with reduced or suppressed transient effects, the modified data representing the earlier interval (e.g. the earlier half) and the later interval (e.g. the later half) may be combined, for example by concatenation (if portions of filtered data are truncated) or addition (if portions of filtered data are nulled).

Applying a filter, such as in steps 202 and 210, involves digital signal processing. An example of applying a filter is to take the discrete convolution of an underlying set of data (e.g. a seismic trace) with the impulse response of the filter. The discrete convolution of a seismic trace array of length M (over a recording time window, or between the start of the window, “tmin”, and the end of the window, “tmax”) and a filter array of length N generally results in an output array of length N+M−1. Artefacts associated with boundary effects may be introduced just outside the boundaries of the recording time window (i.e. at t<tmin and t>tmax). It is therefore necessary to truncate the output array to, for example, the recording time window of length M, or null the output array outside the recording time window of length M, or otherwise remove the boundary-associated artefacts. If these boundary-associated artefacts are not removed, any further discrete convolution (e.g. during phase removal by a phase removal filter array as further described below) would re-introduce unwanted energy within the recording time window. Truncation steps 204 and 212 are intended to remove the boundary-associated artefacts.

In some arrangements, the modified data representing the earlier interval may be the earliest one-third of the seismic trace (whereas the later two-thirds are disregarded), and the modified data representing the later interval may be the latest one-third of the seismic trace (whereas the earlier two-thirds are disregarded). In these arrangements, data representing an intermediate interval (e.g. middle one-third) of the filtered seismic trace (e.g. filtered by any low-cut filter, whether or not causal or anti-causal) may be combined with the modified data (e.g. the earliest and latest one-thirds) to generate a full low-cut filtered seismic trace with reduced or suppressed transient effects. Whether two portions or three portions are combined to generate a full low-cut filtered seismic trace, their corresponding intervals may be of different and arbitrary lengths subject to two constraints: a) The length of one such portion to be filtered is at least twice the filter length, and, b) the point of division between the earlier and later parts of one portion must be at least one filter length from both ends of the portion to be filtered.

In general, the phase spectrum of the causal and/or anticausal filter imposes an unwanted or undesirable phase on the filtered data. In method 200, steps 206 and 214 are to remove the phase of the truncated data. To remove the phase effects of the filter on the truncated data, steps 206 and 214 may each apply a phase removal filter. The phase removal filter may include an all-pass filter with a conjugate phase of the causal filter, or a time-reversed version of the causal filter. FIG. 4 illustrates the filtered output 304 of FIG. 3 having been (1) nulled and (2) applied with a time reversed version of the causal filter for phase removal. The phase-removed result is illustrated as line 402.

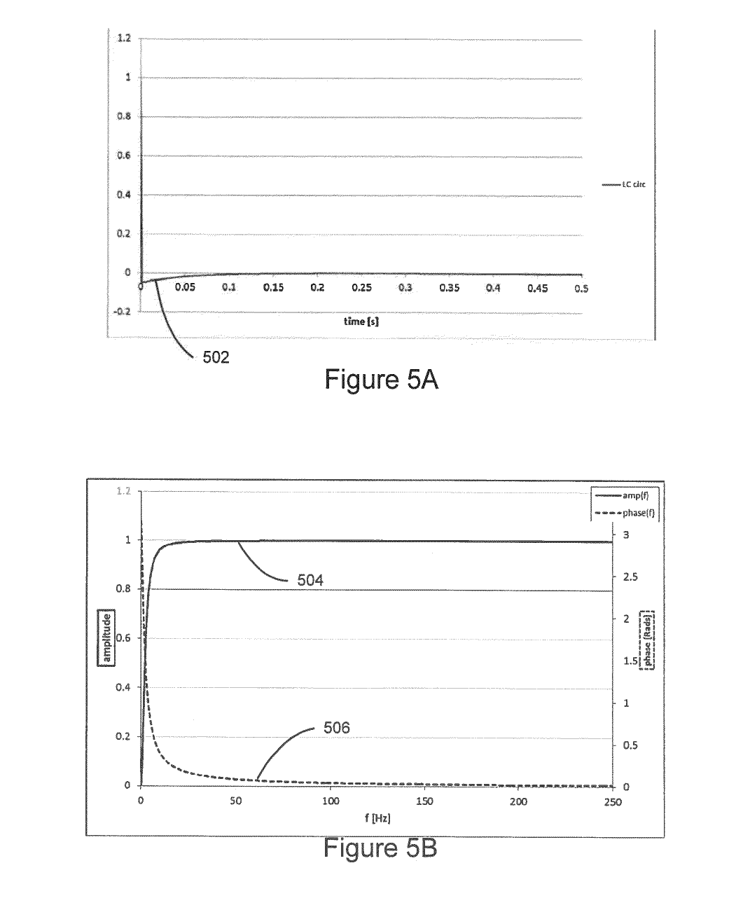

FIGS. 5A and 5B show the impulse response 502 and the frequency response (amplitude 504 and phase 506) of an example of a causal filter suited for use in the present disclosure. The illustrated example is a RC low-cut filter with a 2 Hz cut off frequency at −6 dB and a 12 dB per octave roll off. An anti-causal filter may be effectively constructed using a causal filter, such as that represented in FIGS. 5A and 5B. In particular, the anti-causal filter may be implemented by (1) time-reversing the input data, (2) applying a causal filter to the time-reversed input data and (3) time-reversing the filtered time-reversed input. The causal filter may be a minimum phase filter and the anti-causal filter may be a maximum phase filter. The causal and anti-causal filters may be a one-dimensional filter (in which the independent variable of the one-dimensional filter is space, frequency or voltage), a two-dimensional F-K filter or an N-dimensional filter.

Accordingly, the disclosed method enables low-cut filtering a truncated segment of data without creating transient effects. For all but the earliest interval of the time window, this is achieved by convolution, truncation and correlation. For all but the latest interval of data, this is achieved by correlation, truncation and convolution. The two resulting sets of data may then be combined (in some cases with data representing an intermediate interval of the window) to provide transient-suppressed low-cut filtered data.

### Application Example

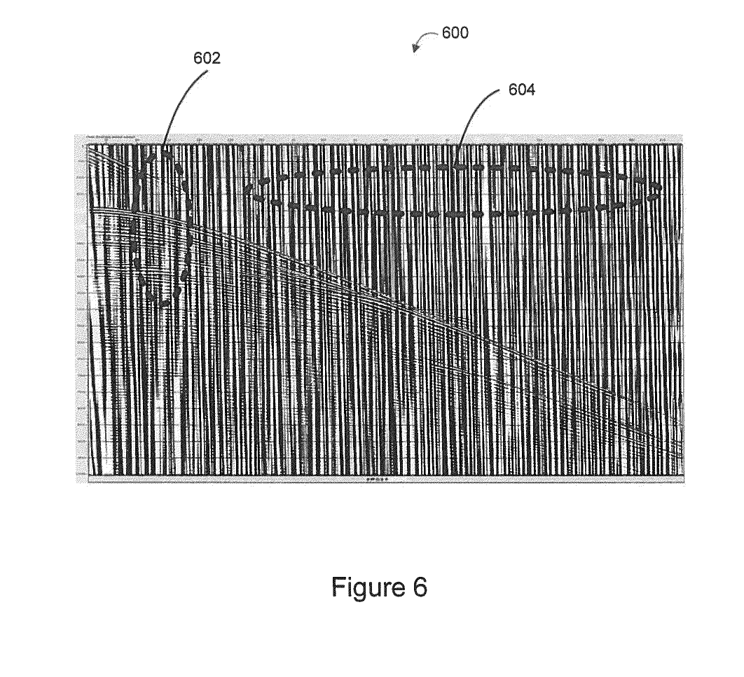

FIG. 6 illustrates towed streamer data 600 obtained in a marine survey acquisition. In some implementations, compressed air is released to generate a seismic source. The response is measured along a towed streamer containing hydrophones. In some implementations, particle velocity is measured by geophones or acceleration is measured by accelerometers in addition to the pressure measurement by hydrophones. The streamer data 600 show received signal amplitude over space (measured in offset distance from the seismic source) and time. The vertical axis represents time (spanning a 5-second interval representing the recording time window) increasing in the downward direction and the horizontal axis represents offset (spanning a 6-km distance) increasing in the right direction. FIG. 6 shows fine lines, for example within the region identified by ellipse 602, oriented diagonally substantially from the top left to the bottom right of the plot arising from, for example, reflections off the seabed and reflections from below the seabed. FIG. 6 also shows substantially vertical lines, for example within the region identified by ellipse 604 (that is, along the direction of the time axis) across the entire plot of FIG. 6. The substantially vertical lines represent unwanted low frequency noise due to, for example, surface waves at or near each offset distance. The small deviation of these lines from vertical represents the movement of the surface waves.

To low-cut filter the streamer data 600 such that signals manifesting as vertical lines identified by ellipse 604 can be reduced or suppressed, the disclosed method 200 may for example be applied. Specifically, in step 202, the streamer data 600 is filtered via discrete convolution by a low-cut causal filter, such as one having responses shown in FIGS. 5A and 5B. In step 204, discrete convolution artefacts are removed by truncation of the causally filtered data to the recording time window (i.e. between tmin and tmax) before application of a phase removal filter. In step 206, the phase of the causally filtered data is removed by applying a phase removal filter. In step 210, the streamer data 600 is filtered via discrete convolution by a low-cut anti-causal filter, such as one based on the low-cut causal filter of FIGS. 5A and 5B, but with each of the input and the output time-reversed. In step 212, discrete convolution artefacts are removed by truncation of the anti-causally filtered data to the recording time window (i.e. between tmin and tmax) before application of a phase removal filter. In step 214, the phase of the anti-causally filtered data is removed by applying a phase removal filter.

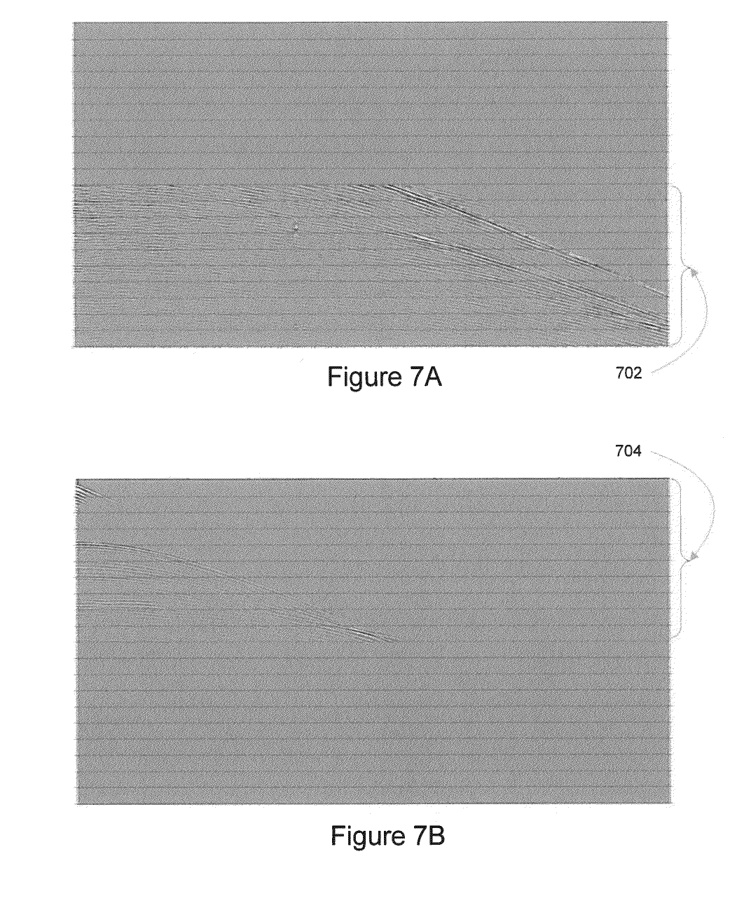

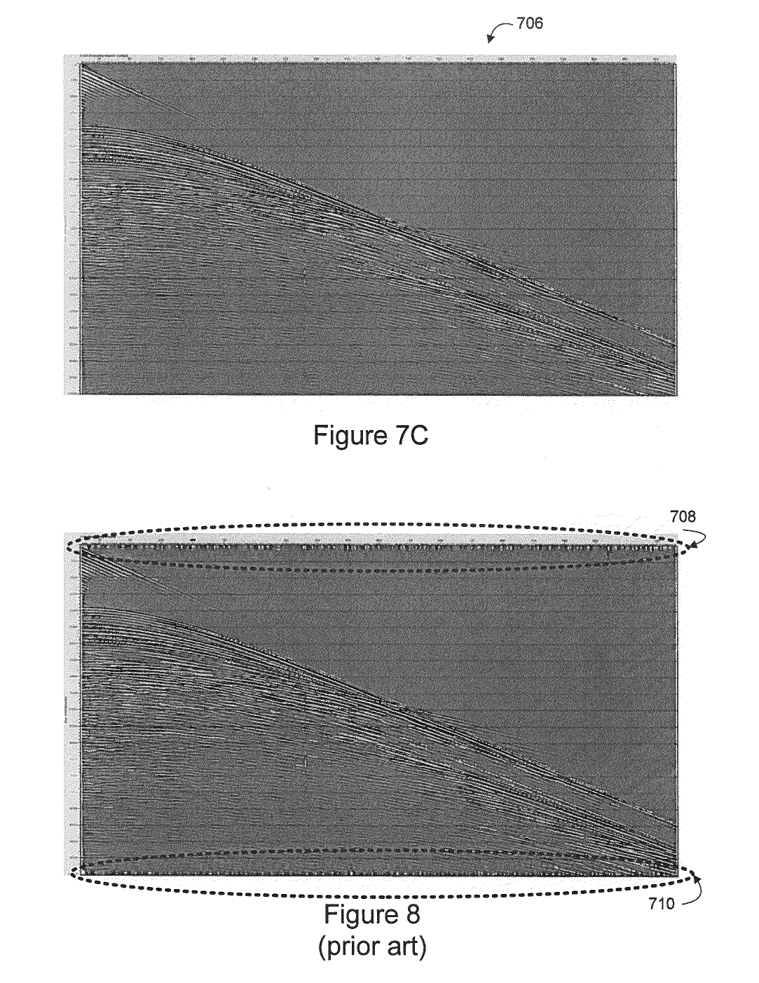

In step 208, a portion of the causally filtered data, representing an earlier half interval of the streamer data, is truncated, nulled or otherwise disregarded. That is, a later half interval of the causally filtered data is selected as first modified data. The later half interval 702 of the causally filtered data is illustrated in FIG. 7A. The low-frequency noise (see lines 604) as well as transient distortions in this portion of the causally filtered data have been suppressed. Similarly, in step 216, a portion of the anti-causally filtered data, representing a later half interval of the streamer data 602, is truncated, nulled or otherwise disregarded. That is, an earlier half interval of the anti-causally filtered data is selected as second modified data. The earlier half interval 704 of the anti-causally filtered data is illustrated in FIG. 7B. Again, the low-frequency noise (see lines 604) as well as transient distortions have been suppressed. In step 210, the earlier half interval 704 of the anti-causally filtered data and the later half interval 702 of the causally-filtered data are combined by concatenation to generate low-cut filtered streamer data 706. The generated low-cut filtered streamer data 706 is shown in FIG. 7C.

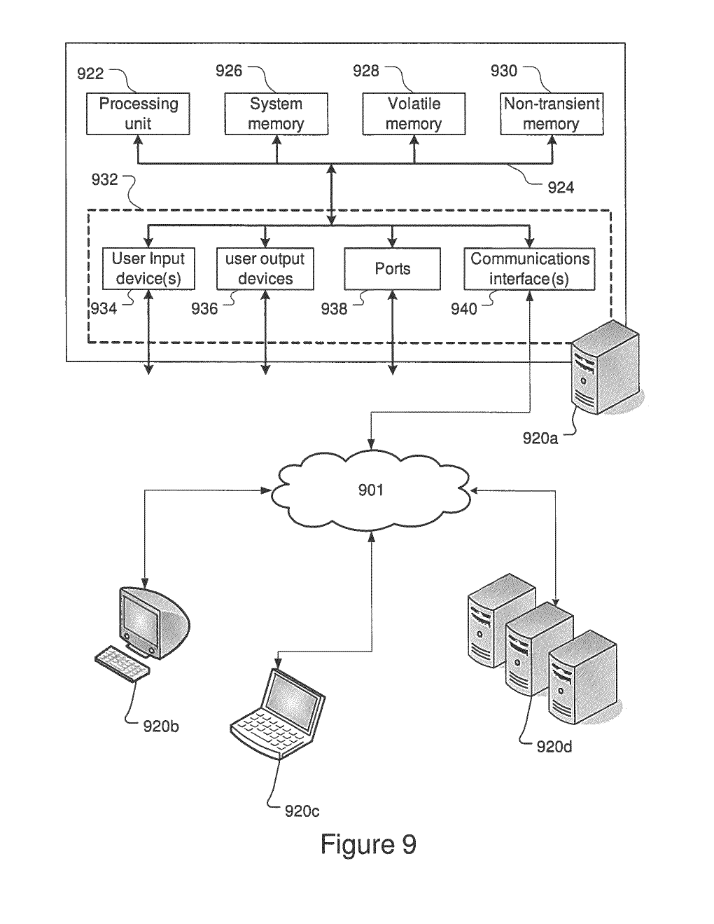

For comparison purposes, FIG. 8 illustrates the result of applying a conventional low-cut filter to the streamer data 600 to remove the low-frequency noise (see lines 604) without application of method 200. While the low-frequency noise is removed, significant distortions are present at the start 708 (towards the top of the plot of FIG. 8) and the end 710 (towards the bottom of the plot of FIG. 9) of the recording time window. Such distortions may mask useful information. In contrast, the streamer data which have been low-cut filtered according to the present disclosure and illustrated in FIG. 7C do not present these significant distortions.

One implementation of the disclosed method performed on streamer data 600 may be summarized in the following pseudo-code:

! --- Obtain necessary data
f(t) = Compute causal low cut filter
d(t) = read(data trace)
tmin = start_time(d(t))
tmax = end_time(d(t))
tmid = (tmax+tmin)/2
! --- compute the front end and tail end results
! --- front end portion
a(t)=truncate(f(+t)*truncate(f(−t)*d(t),tmin,tmax),tmin,tmid)
! --- tail end portion
b(t)=truncate(f(−t)*truncate(f(+t)*d(t),tmin,tmax),tmid,tmax)
! --- put the two halves together in g and output
g(t) = a(t)+b(t)
save(g(t))

In the above pseudo code, d(t) represents streamer data 600, a(t) represents the earlier half interval 704 of the anti-causally-filtered data, b(t) represents the later half interval 702 of the causally-filtered data, f(+t) and f(−t) are the time-forward and time-reverse filter functions, respectively, representing a causal filter and an anti-causal filter, respectively, and g(t) represents the low-cut filtered streamer data 706. tmin, tmid and tmax represent the beginning, the mid-point and the end of the recording time window. The asterisk * denotes a convolution operation. The time reversal indicated in f(−t)* is equivalent to a correlation operation (i.e. convolution with one time series reversed. That is, f(−t)* denotes correlation with f(+t). Using the 5-second recording time window of FIG. 6 as an example, tmin corresponds to t=0 second and tmax corresponds to t=5 second.

FIG. 2 corresponds to the pseudo-code above. For the earlier interval (i.e. “front end”) of the seismic trace, d(t) is (1) discretely convolved with f(−t), (2) truncated to the time-recoding window, (3) discretely convolved with f(+t), and (4) truncated to the earlier half interval of the recording time window to generate a(t). For the later interval (i.e. “tail end”) of the seismic trace, d(t) is (1) discretely convolved with f(+t), (2) truncated to the time-recoding window, (3) discretely convolved with f(+t), and (4) truncated to the later half interval of the recording time window to generate b(t). The low-cut filtered streamer data g(t) is then generated by combining a(t) and b(t) by, for example, concatenation to form filtered data spanning the full interval of the recording time window.

In one example, the pseudo code may be implemented as a series of matrix operations. Specifically, the filter operation may be represented in convolutional form:

$$F = [ \begin{matrix}{f}_{0} & … & … & … & … & … \\ {f}_{1} & {f}_{0} & … & … & … & … \\ … & {f}_{1} & {f}_{0} & … & … & … \\ … & … & {f}_{1} & {f}_{0} & … & … \\ … & … & … & {f}_{1} & {f}_{0} & … \\ … & … & … & … & {f}_{1} & {f}_{0}\end{matrix} ] , \qquad ( 1.1 )$$

and the truncation operations in matrix form,

$${T}_{1} = [ \begin{matrix}… & … & … & … & … & … \\ … & 1 & … & … & … & … \\ … & … & 1 & … & … & … \\ … & … & … & 1 & … & … \\ … & … & … & … & 1 & … \\ … & … & … & … & … & …\end{matrix} ] , \\ {T}_{a} = [ \begin{matrix}… & … & … & … & … & … \\ … & 1 & … & … & … & … \\ … & … & 1 & … & … & … \\ … & … & … & … & … & … \\ … & … & … & … & … & … \\ … & … & … & … & … & …\end{matrix} ] , and \\ {T}_{b} = [ \begin{matrix}… & … & … & … & … & … \\ … & … & … & … & … & … \\ … & … & … & … & … & … \\ … & … & … & 1 & … & … \\ … & … & … & … & 1 & … \\ … & … & … & … & … & …\end{matrix} ] , \qquad ( 1.2 )$$

so that the disclosed method 200 may be described as,

(TₐFT₁F^{T}+T_{b}F^{T}T₁F)d=g, (1.3)

where F^{T} represents the transpose of F.

As will be appreciated by a skilled person, there are a wide range of orders in which the operations in Equation (1.3) may be implemented. For instance, addition is associative and commutative. Multiplication is associative and left/right distributive over addition. Accordingly, the following forms of evaluation of g, for example, are each equivalent to Equation (1.3):

g=(TₐFT₁F^{T}+T_{b}F^{T}T₁F)d

g=(TₐFT₁F^{T})d+(T_{b}F^{T}T₁F)d.

g=[Tₐ(FT₁F^{T})+T_{b}(F^{T}T₁F)]d

It should be apparent that the method 200, if implemented by matrix operations, has been explicitly described as:

Tₐ(F(T₁(F^{T}d)))+T_{b}(F^{T}(T₁(Fd)))=TₐFT₁F^{T}d+T_{b}F^{T}T₁Fd=g. (1.4)

It should also be apparent to a skilled person that although the brackets in Equation (1.4) explicitly order the evaluation sequence, they are not strictly necessary since matrix algebra is by convention evaluated left to right. Further. it should also be apparent that the operator F is equivalent to a convolution operation in the time domain or a multiplication operation in the Fourier or frequency domain.

In some cases meta-languages may be used to implement the disclosed method. For example in ProMAX/SeiSpace, the disclosed method may be executed by the following sequence:

Javaseis Data Input <- d
User-Defined Filter (correlation)
User-Defined Filter (convolution)
JavaSeis Data Output -> a
----- Add Flow Comment -----
Javaseis Data Input <- d
User-Defined Filter (convolution)
User-Defined Filter (correlation)
JavaSeis Data Output -> b
----- Add Flow Comment -----
Javaseis Data Input <- a
Javaseis Data Combine <- b
Trace Math (sum trace pairs)
JavaSeis Data Output -> g

### Computer Implementation

As noted, the disclosed method may be implemented using a computer system. In general, as depicted in FIG. 9, the corresponding system includes one or more of computer processing systems 920a-920d. Computer processing systems 920a-920d may be communicatively coupled via a communications network 901. Communications network 901 may include, for example, any one or more of a wired, wireless, satellite, microwave and fibre optic communications network. The computer processing systems may be, respectively, a computer server 920a, a desktop computer 920b, a laptop computer 920c, or a computer server system 920e. For example, method 200 may be executed on computer server 920a, whereas streamer data for processing may be stored in computer server system 920e. As another example, several computer processing systems, such as computer processing systems 920a and 920d may execute the method cooperatively using distributed computing techniques.

Each of computer processing systems 920a-920d includes at least one processing unit 922 which may be a single computational processing device (e.g. a microprocessor or other computational device) or a plurality of computational processing devices. Through a communications bus 924, processing unit 922 is in data communication with a system memory 926 (e.g. a read only memory storing a BIOS for basic system operations), a volatile memory 928 (e.g. random access memory such as one or more DRAM modules), and a non-transient memory 930 (e.g. one or more hard disk drives, solid state drives, flash memory devices and suchlike). Instructions and data to control operation of processing unit 922 are stored on system, volatile, and/or non-transitory memories 926, 928, and 930. For example, computer codes for executing method 200 may be stored in or downloaded into memories 926, 928 and 930 and/or generated by processing unit 922 based on instructions stored in or downloaded into memories 926, 928 and 930.

At least one computer processing systems 920a-d may also include one or more input/output interfaces 932 which allow system 920 to interface with a plurality of input/output devices 934 and 936, or via one or more ports 938. As will be appreciated, a wide variety of input/output devices may be used depending on the device/system/apparatus in question, for example keyboards, pointing devices, touch-screens, touch-screen displays, displays, microphones, speakers, hard drives, solid state drives, flash memory devices and the like. Computer processing system 920 also includes one or more network communications interfaces 940, such as Network Interface Cards, modems and the like, allowing for wired and/or wireless connection to communications network 901. For example, communications network 901 may include am intranet. Alternatively, communications network 901 may include the Internet which enables communications between a server and a client remote from each other.

Computer processing system 920 stores in memory and runs one or more applications allowing operators to locally or remotely operate or manage system 920. Such applications will typically include at least an operating system such as Microsoft Windows, Apple OSX, Unix, Linux, Apple iOS, Google Android, or other operating system.

Communication with communications network 901 (and other devices, apparatuses, servers, apparatuses connected thereto) may be by the protocols set out in the layers of the Open Systems Interconnection (OSI) model of computer networking. For example, applications/software programs being executed by computer processing system 920 may communicate using one or more transport protocols, e.g. the Transmission Control Protocol (TCP) or the User Datagram Protocol (UDP). Alternative communications protocols may, of course, be used. For data transfer tasks, systems 902a-d may use protocols such as the File Transfer Protocol (FTP).

While FIG. 9 provides a general overview of suitable computer processing systems, it should be appreciated that the server and user devices described herein may be of alternative system types. Further, and as noted, each different system may have different I/O interfaces and I/O devices, different communications interfaces, and/or different software applications installed. Further, the disclosed method may be partially, additionally or alternatively implemented using customized hardware, such as one or more Digital Signal Processors (DSPs), Field Programmable Gate Arrays (FPGAs) or Application Specific Integrated Circuits (ASICs).

It will be understood that the invention disclosed and defined in this specification extends to all alternative combinations of two or more of the individual features mentioned or evident from the text or drawings. For example, step 202 may use a causal filter not characterized by the responses shown in FIGS. 5A and 5B. As noted, steps 204 and 206, or steps 202 and 204, may be swapped. All of these different combinations constitute various alternative aspects of the invention.

As used herein, except where the context requires otherwise, the term “comprise” and variations of the term, such as “comprising”, “comprises” and “comprised”, are not intended to exclude further additives, components, integers or steps.

As used herein, except where the context requires otherwise, terms such as “first”, “second” and “third” are used arbitrarily to distinguish between like elements such terms describe, and do not necessarily denote order or timing, or the preferred order timing of such elements.

What is claimed is:

1. A computer-implemented method of low-cut filtering a seismic trace recorded over a recording time window, the method comprising:
applying a causal low-cut filter to the seismic trace to generate first filtered data;
applying an anti-causal low-cut filter to the seismic trace to generate second filtered data;
truncating the first filtered data to generate first truncated data based on the recording time window;
truncating the second filtered data to generate second truncated data based on the recording time window;
removing the phase of the first truncated data;
removing the phase of the second truncated data;
selecting a portion of the first phase-removed truncated data to generate first modified data, the selected portion of the first phase-removed truncated data being associated with a later time interval of the seismic trace;
selecting a portion of the second phase-removed truncated data to generate second modified data, the selected portion of the second phase-removed truncated data being associated with an earlier time interval of the seismic trace; and
generating a low-cut filtered seismic trace by combining at least the first modified data and the second modified data.

2. The method of claim 1 wherein the step of removing the phase of the first truncated data includes applying a phase removal filter to the first truncated data.

3. The method of claim 2 wherein the phase removal filter includes an all-pass filter with a conjugate phase of the causal filter.

4. The method of claim 2 wherein the phase removal filter includes a time-reversed version of the causal filter.

5. The method of claim 1 wherein the step of removing the phase of the second truncated data includes applying a phase removal filter to the second truncated data.

6. The method of claim 5 wherein the phase removal filter includes an all-pass filter with a conjugate phase of the anti-causal filter.

7. The method of claim 5 wherein the phase removal filter includes a time-reversed version of the anti-causal filter.

8. The method of claim 1 wherein applying a causal low-cut filter to the seismic trace to generate first filtered data includes computing discrete convolution of the seismic trace and the impulse response of the causal low-cut filter, and wherein truncating first filtered data includes removing convolution artefacts arising from the discrete convolution.

9. The method of claim 8 wherein truncating to remove convolution artefacts includes truncating to the recording time window of the seismic trace.

10. The method of claim 1 wherein applying an anti-causal low-cut filter to the seismic trace to generate second filtered data includes computing discrete convolution of the seismic trace and the impulse response of the anti-causal low-cut filter, and wherein truncating second filtered data includes removing convolution artefacts arising from the discrete convolution.

11. The method of claim 10 wherein truncating to remove convolution artefacts includes truncating to the recording time window of the seismic trace.

12. The method of claim 1 wherein the earlier interval of the seismic trace and the later interval of the seismic trace are each a temporal half of the seismic trace.

13. The method of claim 1 wherein the seismic trace includes an intermediate interval between the earlier interval and the later interval of the seismic trace, and wherein generating a low-cut filtered seismic trace includes combining the first modified data, the second modified data and data associated with the intermediate interval.

14. The method of claim 1 wherein the causal filter is a minimum phase filter.

15. The method of claim 1 wherein the anti-causal filter is a maximum phase filter.

16. The method of claim 1 wherein the anti-causal or causal low-cut filter includes a cut off frequency of 2 Hz or less.

17. The method of claim 1 wherein the anti-causal or causal low-cut filter includes an amplitude roll off of 12 dB per octave.

18. The method of claim 1 wherein the anti-causal or causal low-cut filter includes a one-dimensional filter.

19. The method of claim 18 wherein the independent variable of the one-dimensional filter is space, frequency or voltage.

20. The method of claim 1 wherein the anti-causal or causal low-cut filter includes a two-dimensional F-K filter.

21. The method of claim 1 wherein the anti-causal or causal low-cut filter includes an N-dimensional filter.

22. A system configured for low-cut filtering a seismic trace, the system comprising:
an input for receiving the seismic trace;
one or more processing units configured to execute the method of any one of claims 1-21;
an output for providing the low-cut filtered seismic trace.

23. A non-transitory machine-readable medium comprising instructions coded thereon for one or more processing units to execute the method of any one of claims 1-21.
